(19) United States
(12) Patent Application Publication
(10) Pub. No.: US 2018/0099329 A1
(43) Pub. Date: Apr. 12, 2018

(54) Metal Castings Including Integral Separately Fabricated Components

(71) Applicant: Quaker City Castings, Salem, OH (US)

(72) Inventor: Geoffrey D. Korff, Salem, OH (US)

(21) Appl. No.: 15/625,063

(22) Filed: Jun. 16, 2017

Related U.S. Application Data
(60) Provisional application No. 62/406,123, filed on Oct. 10, 2016.

(51) Int. Cl. B22C 9/10; B22C 9/02; B22D 19/04; B22D 29/00; B33Y 80/00; B33Y 10/00

(52) U.S. Cl. CPC B22C 9/103; B22C 9/02; B33Y 10/00; B22D 29/001; B33Y 80/00; B22D 19/04

(57) ABSTRACT

A method of integrating separately fabricated parts into a metal casting involves additively manufacturing a sand core having voids, inserting separately fabricated parts into the sand core, placing the sand core into a sand mold, and pouring molten metal into the sand mold to surround the sand core. Upon removal or the sand core and sand mold from the resulting casting, the separately fabricated or separately cast parts remain integral to the resulting casting.

### FIELD

The present subject matter relates to processes of integrating separately fabricated components into a metal casting using additively manufactured cores.

### BACKGROUND

Conventional methods of affixing separately fabricated components to/into metal castings typically include welding or other costly, time consuming and/or imprecise procedures.

As such, there is a need to improve methods of joining or affixing separately fabricated parts into metal castings. Accordingly, there exists a need for improved procedures for such joining that address the shortcomings of the previous techniques.

### SUMMARY

The difficulties and drawbacks associated with previously known systems are addressed in the presently described methods.

### BRIEF DESCRIPTION OF THE DRAWINGS

FIG. 1 depicts an additively manufactured core of the invention.

FIG. 2 depicts a loaded core of the invention.

FIG. 3 depicts a close up view of a loaded core of the invention.

FIG. 4 depicts a loaded core of the invention ready to be inserted into a sand mold.

FIG. 5 depicts a loaded core of the invention inserted into a sand mold.

FIG. 6 depicts a cope and drag of a sand mold into which the loaded core will be inserted.

FIG. 7 depicts the loaded core inserted into the sand mold about to be closed.

FIG. 8 depicts molten metal being poured into a closed sand mold.

FIG. 9 depicts a rough casting of the invention.

FIG. 10 depicts the final casting of the invention with integral separately fabricated parts.

FIGS. 11-13 depict alternate embodiments of a core (both empty and loaded), and separately fabricated parts of the invention.

### DETAILED DESCRIPTION OF THE EMBODIMENTS

The present subject matter provides methods of integrating separately fabricated parts into cast metal components (such as castings) and the components produced by such methods.

While the presently disclosed and claimed methods can be used to incorporate or integrate almost any imaginable separately fabricated or separately cast component into almost any metal casting, the exemplary non-limiting embodiments detailed herein relate to components for gas turbines. In particular, the inventive methods and components relate to gas turbine diaphragms and their fabrication, and more particularly, to methods of incorporating separately fabricated or separately cast vanes or blades into a gas turbine diaphragm.

A gas turbine, also called a combustion turbine, is a type of internal combustion engine. It has an upstream rotating compressor coupled to a downstream turbine, and a combustion chamber in between.

The basic operation of the gas turbine is similar to that of a steam power plant except that air is used instead of water. Fresh atmospheric air flows through a compressor that increases its pressure. Energy is then added by spraying fuel into the air and igniting it so the combustion generates a high-temperature flow. This high-temperature high-pressure gas enters a turbine, where it expands down to the exhaust pressure, producing a shaft work output. The turbine shaft work is used to drive a compressor and other devices such as an electric generator that may be coupled to the shaft. The energy that is not used for shaft work comes out in the exhaust gases, which may have a high temperature or a high velocity. The purpose of the gas turbine determines the design so that the most desirable energy form is maximized. Gas turbines are used to power aircraft, trains, ships, and electrical generators

There are several major assemblies in a gas turbine that are necessary to direct the air flow through the turbine. The present invention relates to, but is not limited to, methods for manufacturing air inlet and air discharge components of the gas turbine and the components so manufactured.

An embodiment of the invention is a method of manufacturing a cast metal component including integral separately fabricated or separately cast parts, the method comprising:
a. additively manufacturing a sand core with at least one void,
b. inserting at least one separately fabricated part or at least one separately cast into the at least one void of the sand core to produce a loaded sand core,
c. providing a sand mold, including at least one cavity,
d. placing the loaded sand core into the at least one void of the sand mold,
e. closing the sand mold,
f. pouring molten metal into the sand mold,
g. cooling the molten metal to form a metal casting, and
h. removing the casting from the sand mold and sand core.

No-bake sand casting is a sand-casting process wherein various types of sand are mixed with a two or three part chemical binder system and added around a pattern to be formed into a mold containing a cavity into which molten metal can be poured for metal casting. Once the sand and binder are combined, the sand mixture hardens after a time depending on sand type, binder type, and mold size. Once the mold is set and forms the mold halves, the pattern is then drawn or removed from the mold. A core (also typically made of sand and binder(s) similar to those of the mold) is usually inserted into the mold cavity to produce various internal casting features.

Additive manufacturing, or 3D printing, is the process of making usable objects from digital models by building-up successive layers of material through various means such as extrusion deposition, polymerization, laser sintering, and several other methods. The invention involves 3D printing foundry sand molds and cores by deposition of successive layers of sand and binder (for example furan binder) until the desired core or mold is created. Although the inventive method relates to additively manufactured cores, it is possible to similarly fabricate sand molds.

In the inventive method, additively manufactured (or “3D printed”) sand cores are designed and printed to allow separately fabricated (for example, extruded, forged, or cast) metal parts such as vanes or blades to be inserted into the cores. The core(s) is/are then placed into the cavity of a sand mold which is may be produced by additive manufacturing or conventional sand molding techniques. Once the mold is closed, molten metal is then poured into the mold. The metal completely surrounds the separately fabricated metal parts and locks them into place in the final casting, for example a diaphragm for a gas turbine.

The figures depict an embodiment of the invention and the associated methods and components.

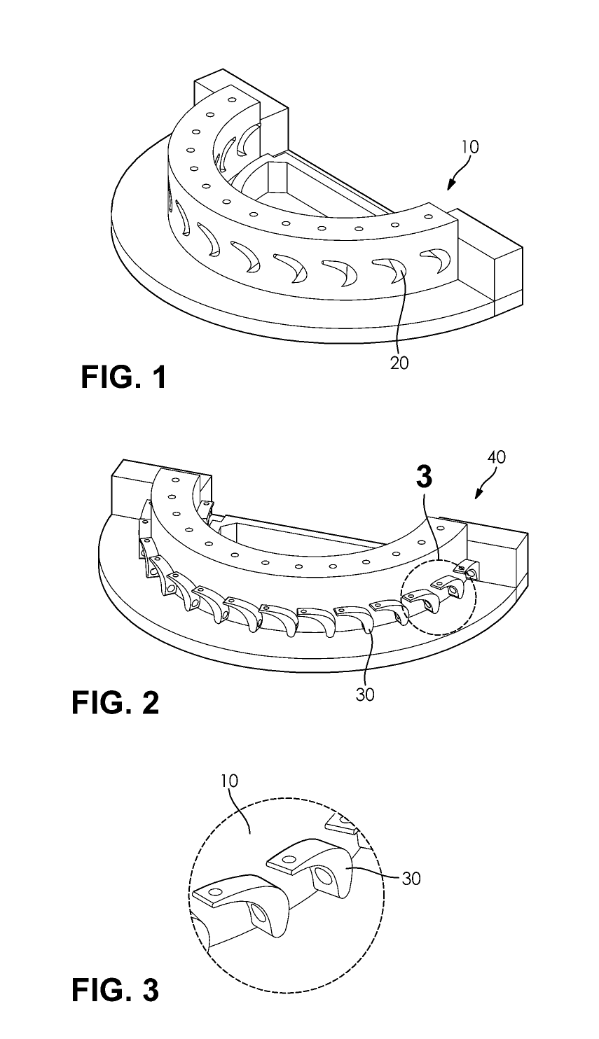

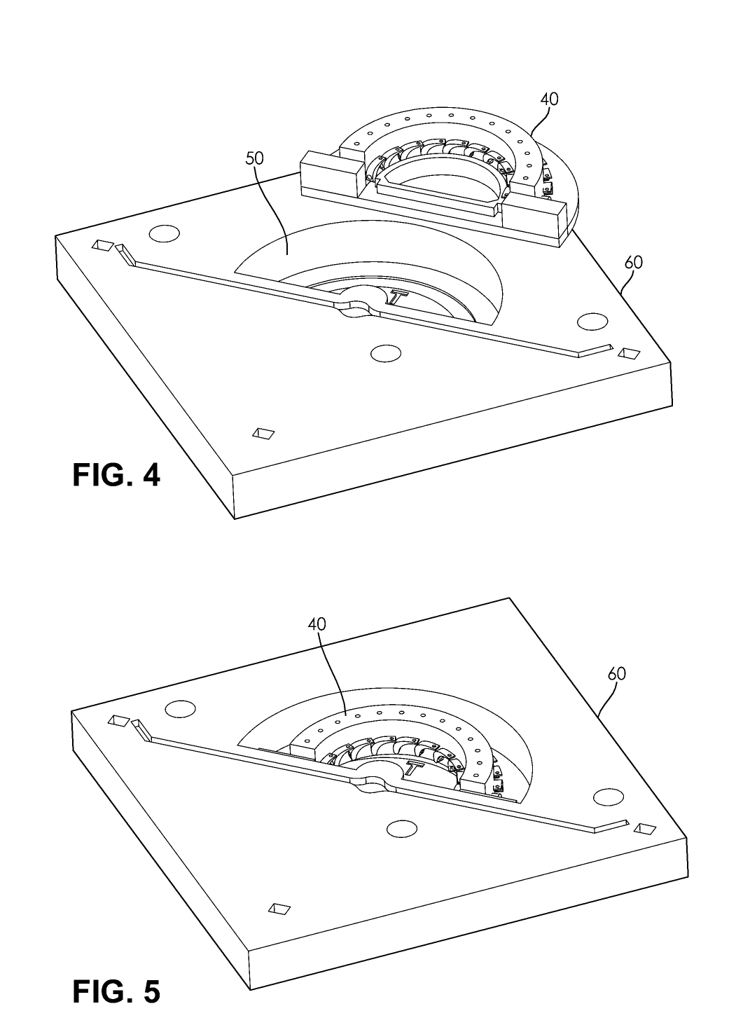

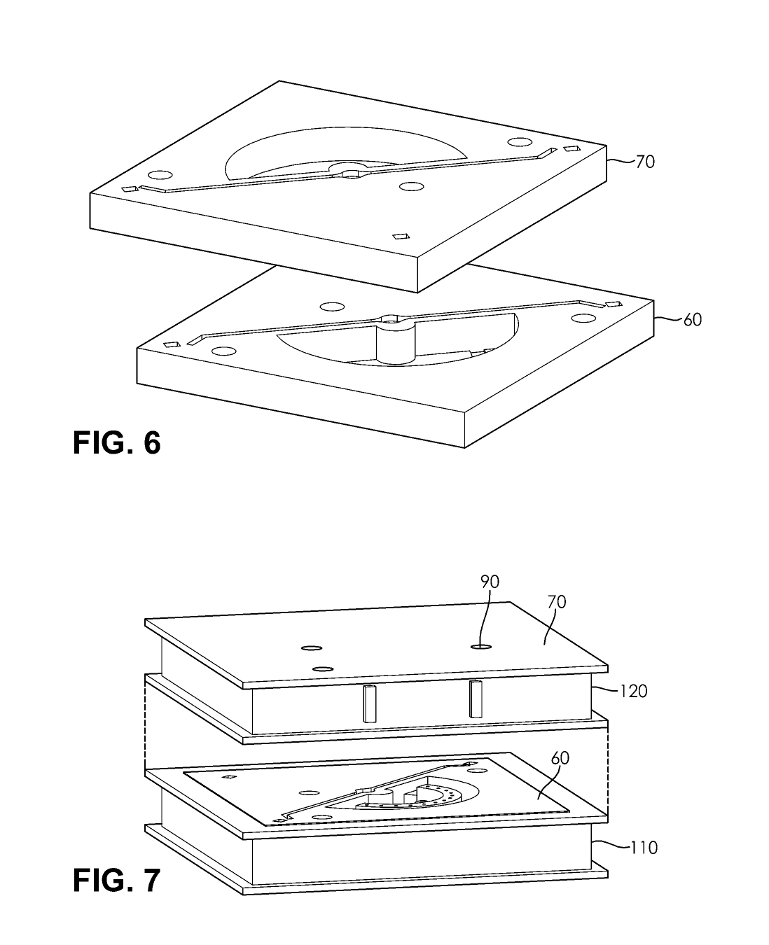

In particular, as shown in FIGS. 1-7, a core 10 is additively manufactured from green sand with a no-bake binder such as a furan or phenol binder. An additive manufacturing device such as a 3D printer from ExOne Company LLC, North Huntingdon, Pa. is suitable to form the cores of the invention. Suitable sands and binders will be known to the skilled artisan. Core 10 is additively manufactured such that it includes one or more voids 20. The voids may take any shape in order to accommodate one or more separately fabricated (or separately fabricated or cast) parts 30. Separately fabricated parts 30 are inserted into voids 20 to form a loaded core 40. A sealant (not shown) may be applied to seal the separately fabricated parts 30 into core 10. In FIGS. 4 and 5, loaded core 40 is placed into mold cavity 50 of the drag 60 of mold 80. Cope 70 including at least one gate 90 is placed over drag 60 holding loaded core 40 in cavity 50 to form a closed sand mold 100. The drag 60 and cope 70 are typically housed in flasks 110 and 120.

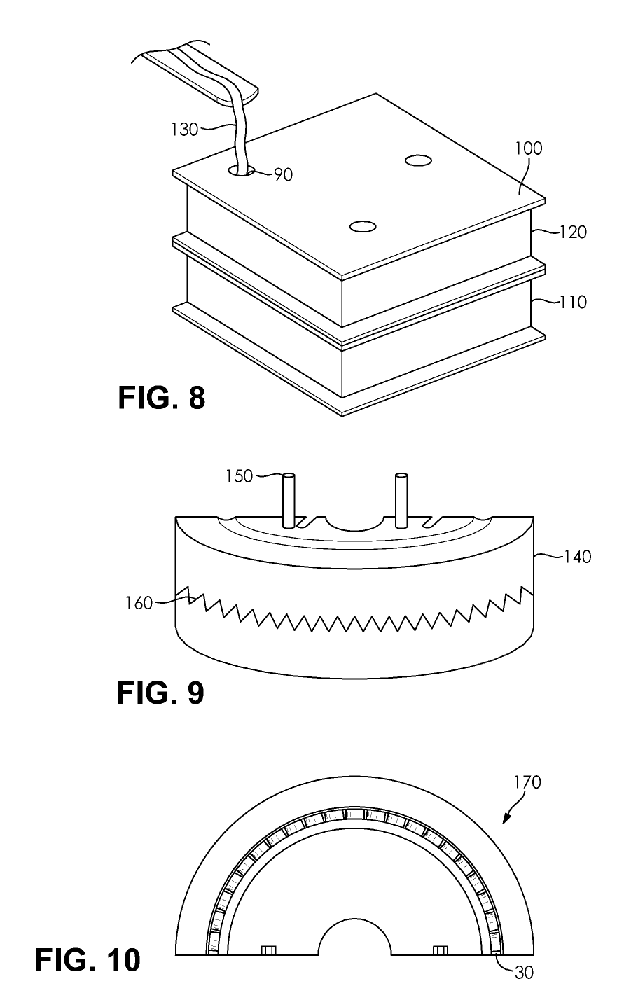

As shown in FIG. 8, molten metal 130 is poured into at least one gate 90 which fills the mold cavity and at least partially surrounds the loaded core 40 thus at least partially surrounding separately fabricated part 30. The molten metal 130 is allowed to cool to solidify, usually to ambient temperature, the result being a rough casting still substantially encased in mold 100. Controlled or uncontrolled cooling techniques may be employed. Upon sufficient cooling, the rough casting is separated from core 10 and closed sand mold 100 and seen as rough casting 140 in FIG. 9. Prior to separation, rough casting may be subjected to heat treatment to modify physical properties and/or crystalline structure of the casting. Rough casting 140 may be further processed, for example, to remove excess metal such as risers 150 and flashing 160, by cutting, grinding, polishing or lathing as is known in the art (such further processing not shown in the figures) to form final casting 170 (also referred to as “cast metal component”), shown in FIG. 10. Final casting 170 includes at least one separately fabricated or separately cast part 30 integral thereto or therein.

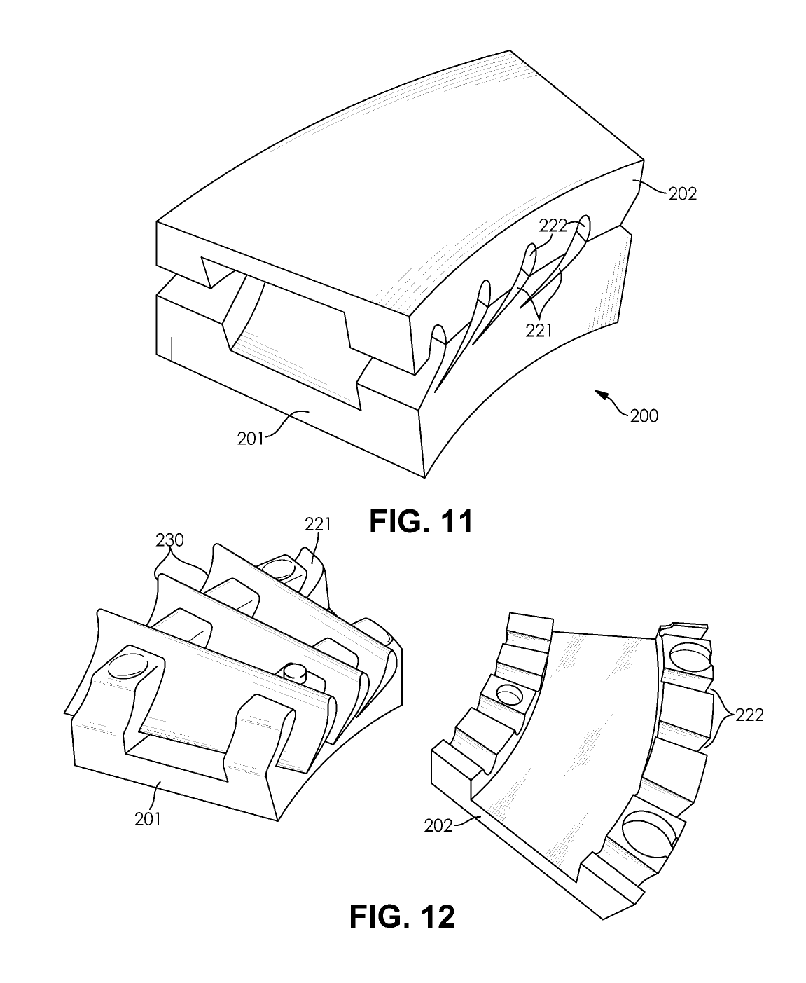

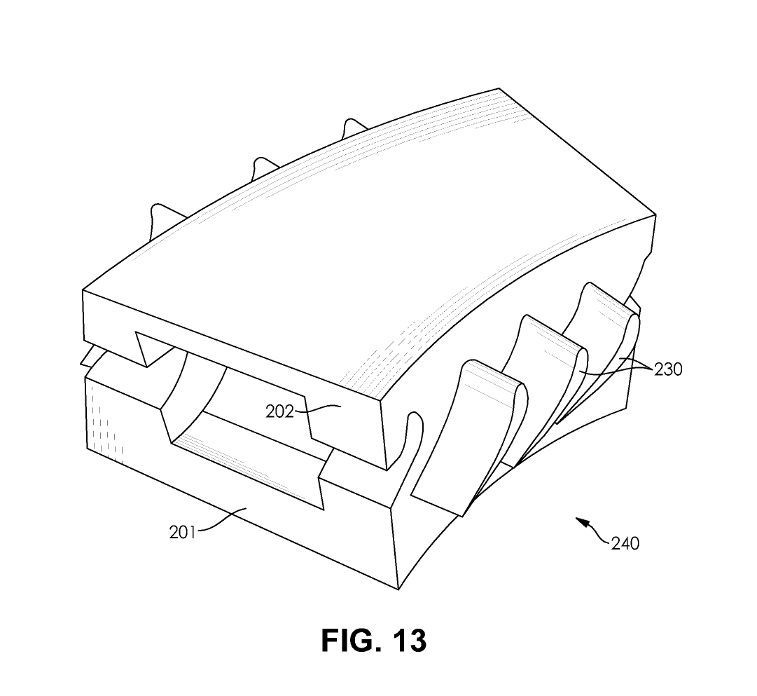

FIGS. 11 and 12 depict the loading and covering of a core of a different embodiment. While similar to the core 10 depicted best in FIGS. 1 and 2, the core here includes lower and upper portions 201 and 202, respectively. It is understood that a core produced by the methods herein can contain multiple portions, which are separable and combinable into one whole core, and may include “upper” and “lower” portions, conceptually similar to a cope and a drag of a sand mold. Lower portion 201 includes one or more voids 221 and upper portion 202 includes one or more voids 222. Separately fabricated parts 230 are inserted into voids 221 and/or 222 and lower and upper portions 201 and 202 are assembled as shown in FIG. 13, to form a loaded core 240. Structures, processes and concepts analogous to those accompanying drawing items 40-170 in paragraphs 25 and 26 may be applied to loaded core 240. The cores, separately fabricated parts and voids may take any size and shape.

The invention is further described by the following items.

Item 1: A method of manufacturing a cast metal component including integral separately fabricated parts, the method comprising:
a. additively manufacturing a sand core with at least one void,
b. inserting at least one separately fabricated part into the at least one void of the sand core to produce a loaded sand core,
c. providing a sand mold, including at least one cavity,
d. placing the loaded sand core into the at least one cavity of the sand mold,
e. pouring molten metal into the sand mold,
f. cooling the molten metal to form a casting,
g. separating the casting from the sand mold and sand core, wherein the at least one separately fabricated part or the at least one separately cast part is integrated into and remains with the casting.

Item 2: The method of item 1 wherein a melting point of the separately fabricated or separately cast part is higher than that of a melting point of the metal poured into the mold to form the casting.

Item 3: The method of items 1-2, wherein the separately fabricated part is extruded.

Item 4: The method of items 1-2, wherein the separately fabricated part is forged.

Item 5: The method of items 1-2, wherein the separately fabricated part is cast.

Item 6: The method of items 1-5, wherein the casting is a gas turbine diaphragm.

Item 7: The method of items 1-6, wherein the at least one separately fabricated part is a rotor vane.

Item 8: The method of item 7, wherein the rotor vane is extruded.

Item 9: The method of item 7, wherein the rotor vane is forged.

Item 10: The method of item 7, wherein the rotor vane is cast.

Item 11: A gas turbine including a cast metal component produced according to the method of item 1.

Item 12, the method of item 1, wherein the sand core comprises two or more portions.

What is claimed is:

1: A method of manufacturing a cast metal component including at least one integral separately fabricated part, the method comprising:
a. additively manufacturing a sand core with at least one void,
b. inserting at least one separately fabricated part into the at least one void of the sand core to produce a loaded sand core,
c. providing a sand mold, including at least one cavity,
d. placing the loaded sand core into the at least one cavity of the sand mold,
e. pouring molten metal into the sand mold,
f. cooling the molten metal to form a casting,
g. separating the casting from the sand mold and sand core, wherein the at least one separately fabricated part is integrated into and remains with the casting.

2: The method of claim 1 wherein a melting point of the separately fabricated or separately cast part is higher than that of a melting point of the metal poured into the sand mold.

3: The method of claim 1, wherein the separately fabricated part is extruded.

4: The method of claim 1, wherein the separately fabricated part is forged.

5: The method of claim 1, wherein the separately fabricated part is cast.

6: The method of claim 2, wherein the separately fabricated part is extruded.

7: The method of claim 2, wherein the separately fabricated part is forged.

8: The method of claim 2, wherein the separately fabricated part is cast.

9: The method of claim 1, wherein the casting is a gas turbine diaphragm.

10: The method of claim 9, wherein the at least one separately fabricated part is a metal rotor vane.

11: The method of claim 9, wherein the rotor vane is extruded.

12: The method of claim 9, wherein the rotor vane is forged.

13: The method of claim 9, wherein the rotor vane is cast.

14: A gas turbine including a cast metal component produced according to the method of claim 1.

15: A gas turbine including a cast metal component produced according to the method of claim 13.

16: The method of claim 1, wherein the sand core comprises at least two separable portions.

17: The method of claim 2, wherein the sand core comprises at least two separable portions.

18: The method of claim 3, wherein the sand core comprises at least two separable portions.

19: The method of claim 4, wherein the sand core comprises at least two separable portions.

20: The method of claim 5, wherein the sand core comprises at least two separable portions.
